(19) United States
(12) Patent Application Publication
(10) Pub. No.: US 2026/0155131 A1
(43) Pub. Date: Jun. 4, 2026

(54) METHOD AND APPARATUS FOR EFFICIENT DIFFUSION TRANSFORMERS FOR SUPERIOR TEXT-TO-AUDIO GENERATION

(71) Applicant: TENCENT AMERICA LLC, Palo Alto, CA (US)

(72) Inventors: Hao ZHANG, Palo Alto, CA (US); Yong XU, Palo Alto, CA (US); Dong YU, Palo Alto, CA (US)

(73) Assignee: TENCENT AMERICA LLC, Palo Alto, CA (US)

(21) Appl. No.: 18/963,841

(22) Filed: Nov. 29, 2024

(51) Int. Cl. G10L 13/027; G10L 13/08

(52) U.S. Cl. CPC G10L 13/027; G10L 13/08

(57) ABSTRACT

A method includes receiving an input audio waveform; inputting the input audio waveform into a variational autoencoder (VAE) to generate a latent representation of the input audio waveform; generating a modified latent representation of the input audio waveform by inputting the latent representation of the input audio waveform and a text prompt into a latent diffusion model; and generating a modified audio waveform by inputting the modified latent representation of the input audio waveform into a VAE decoder.

### FIELD

The disclosure generally relates machine learning and artificial intelligence, specifically to the domain of generative models for converting textual data into audio outputs.

### BACKGROUND

The field of text-to-audio (T2A) generation has evolved significantly, leveraging advancements in latent diffusion models originally developed for text-to-image (T2I) generation, such as Stable Diffusion. Previous approaches to T2A generation primarily involved the transformation of text into 2D mel spectrograms, treating the spectrograms as images and using U-Net-based architectures for diffusion sampling. However, these methods have encountered several key challenges, including high computational costs, difficulty in maintaining temporal resolution, and suboptimal compatibility with downstream applications such as ControlNet, which typically rely on 1D conditions.

Recent developments, such as Make-An-Audio-2, have explored the use of a 1D Variational Autoencoder (VAE) to replace mel spectrograms with 1D waveform latents, improving generation quality. However, reconstructing audio from mel spectrograms can still lead to degraded audio quality, especially for complex audio types like music and sound effects. Additionally, current approaches often require a separate neural vocoder to convert the spectrogram into a usable waveform, further increasing complexity and computational demands.

Another significant challenge in T2A generation is the lack of large-scale annotated audio datasets. Previous efforts, such as AudioLDM, have used unlabeled data embeddings like CLAP, but have struggled with mismatches between text and audio embeddings, leading to lower generation quality. Other methods, such as Make-An-Audio [6], [10], have relied on synthetic data, but the non-open-source nature of these datasets and the time-consuming process of generating synthetic audio have hindered progress. Even with datasets like TangoPromptBank, issues of inconsistency and poor quality have limited the effectiveness of these approaches.

### SUMMARY

According to an aspect of the disclosure, a method performed by at least one processor includes: receiving an input audio waveform; inputting the input audio waveform into a variational autoencoder (VAE) to generate a latent representation of the input audio waveform; generating a modified latent representation of the input audio waveform by inputting the latent representation of the input audio waveform and a text prompt into a latent diffusion model; and generating a modified audio waveform by inputting the modified latent representation of the input audio waveform into a VAE decoder.

According to an aspect of the disclosure, an apparatus includes: at least one memory configured to store program code; and at least one processor configured to read the program code and operate as instructed by the program code, the program code including: receiving code configured to cause the at least one processor to receive an input audio waveform; first inputting code configured to cause the at least one processor to input the input audio waveform into a variational autoencoder (VAE) to generate a latent representation of the input audio waveform; first generating code configured to cause the at least one processor to generate a modified latent representation of the input audio waveform by inputting the latent representation of the input audio waveform and a text prompt into a latent diffusion model; and second generating code configured to cause the at least one processor to generate a modified audio waveform by inputting the modified latent representation of the input audio waveform into a VAE decoder.

According to an aspect of the disclosure, a non-transitory computer readable medium having instructions stored therein, which when executed by a processor cause the processor to execute a method including: receiving an input audio waveform; inputting the input audio waveform into a variational autoencoder (VAE) to generate a latent representation of the input audio waveform; generating a modified latent representation of the input audio waveform by inputting the latent representation of the input audio waveform and a text prompt into a latent diffusion model; and generating a modified audio waveform by inputting the modified latent representation of the input audio waveform into a VAE decoder.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIG. 3 is a block diagram of a latent diffusion model, according to embodiments.

FIG. 4 is a block diagram of an example configuration of diffusion transformer blocks, according to embodiments.

FIG. 5 is a block diagram of an example configuration of diffusion transformer blocks, according to embodiments.

FIG. 6 is a block diagram of an example variants of adaptive layer normalization, according to embodiments.

FIG. 7 is a flowchart of an example audio generation process, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

Embodiments of the present disclosure are directed to a transformer-based T2A diffusion model (e.g., EzAudio) that operates in waveform latent space, reducing computational complexity while enhancing audio fidelity and temporal resolution. Additionally, the invention presents an efficient training strategy that leverages a combination of unlabeled data, audio-language model-generated captions, and human-labeled data to improve text-to-audio alignment and overall generation quality.

The embodiments of the present disclosure provide an innovative and efficient solution to the challenges of T2A generation by utilizing a transformer-based diffusion model designed for waveform latent spaces. This approach overcomes the limitations of previous models in several key areas.

According to one or more embodiments, EzAudio leverages a 1D waveform Variational Autoencoder (VAE), bypassing the complexities of handling 2D mel spectrograms and eliminating the need for an additional neural vocoder. This results in a streamlined model that reduces computational costs and enhances temporal resolution while maintaining high-quality audio reconstructions.

The embodiments introduce a novel transformer architecture specifically designed for audio latent representations and diffusion modeling. This architecture incorporates adaptive layer normalization (AdaLN), long-skip connections, and advanced techniques such as RoPE and QK-Norm, which improve model convergence, stability, and memory efficiency. These innovations allow for faster training times and reduced memory usage compared to existing models like DiT.

The embodiments of the present disclosure provide a data-efficient training strategy. For example, to address the problem of data scarcity, EzAudio employs a three-stage training pipeline using open-source datasets such as Audioset, VGGSound, and AudioCaps. The training pipeline begins with masked modeling to learn acoustic dependencies, followed by text-to-audio alignment training using audio captions generated and refined by audio-language models and human-labeled data for final fine-tuning. This approach ensures superior generation quality and robust prompt alignment.

The embodiments of the present disclosure use Classifier-Free Guidance (CFG) Rescaling. For example, EzAudio incorporates a classifier-free guidance (CFG) rescaling method that allows for stronger prompt alignment without compromising audio fidelity. This innovation ensures that users can easily balance CFG scores to achieve optimal generation quality without the need for extensive fine-tuning.

The embodiments of the present disclosure significantly outperform existing open-source T2A models in both objective metrics and subjective evaluations, delivering highly realistic audio while maintaining a streamlined, easy-to-follow training process. The embodiments of the present disclosure reduce computational overhead, improve generation quality, and provide a publicly available codebase, dataset, and pre-trained models to facilitate further research and practical applications in areas such as multimedia content creation and interactive systems.

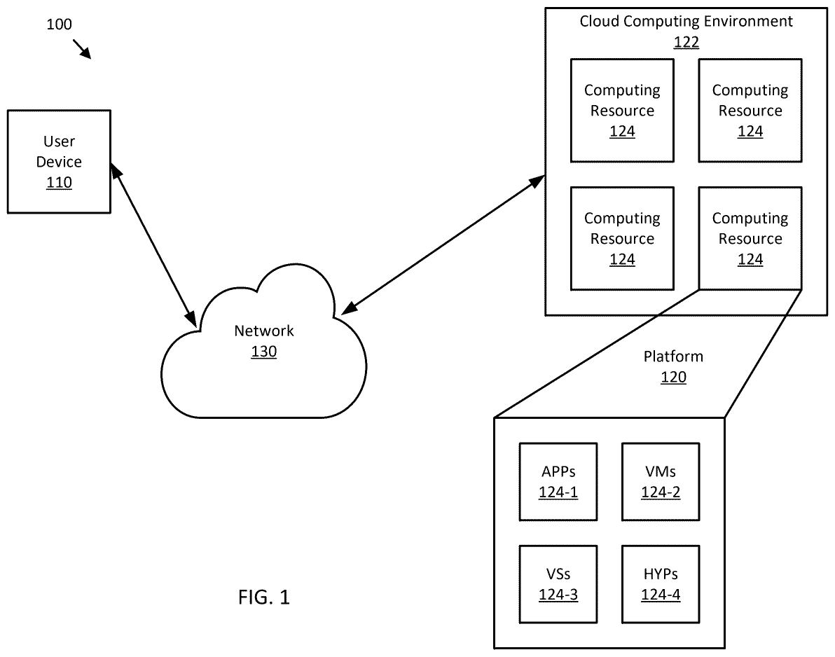

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSS) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

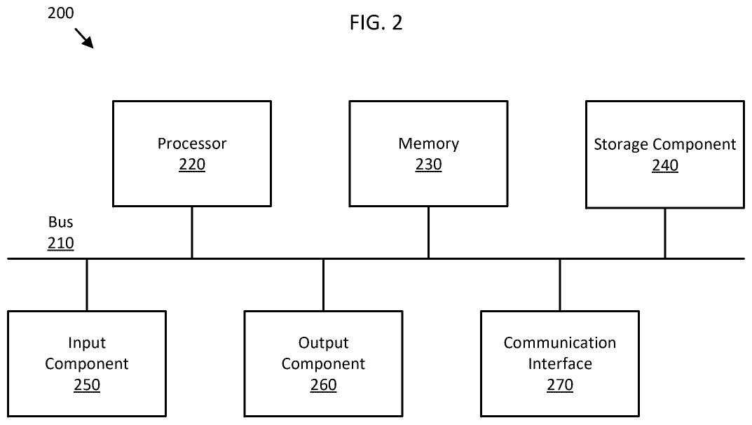

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

Embodiments of the present disclosure are directed to a novel approach for text-to-audio (T2A) generation by employing a transformer-based diffusion model (e.g., EzAudio) that operates on waveform latent spaces. The embodiments of the present disclosure addresses critical issues related to computational efficiency, model stability, and audio fidelity by incorporating several innovative design components and a multi-stage training strategy.

According to one or more embodiments, EzAudio's architecture includes a text encoder, a latent diffusion model (LDM), and a waveform Variational Autoencoder (VAE).

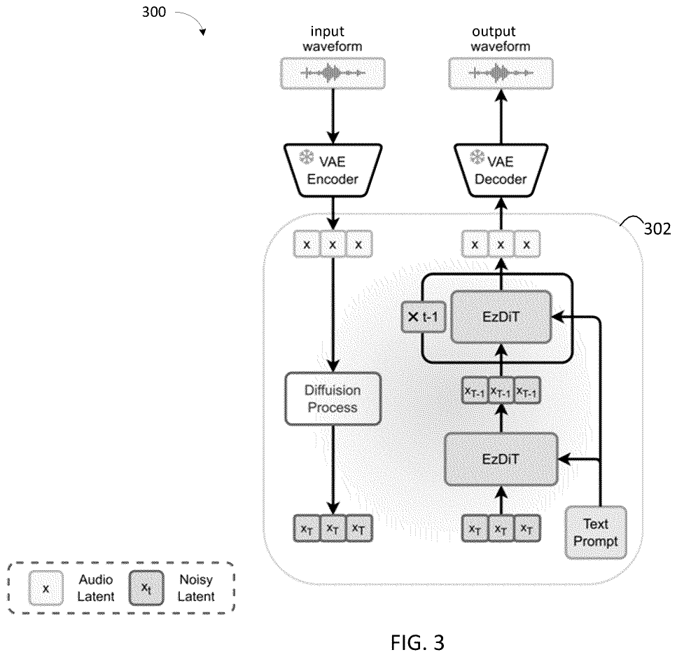

FIG. 3 illustrates an example system architecture 300 that includes an LDM 302 in accordance with EzAudio. The text encoder processes the input text (audio description) and outputs a feature embedding that is used by the LDM 302 to guide the diffusion process. For example, the text prompt may be a text instruction to convert input audio to an output audio (e.g., text instruction to convert input audio in English to French). The LDM 302 operates in the latent space of the VAE, starting from Gaussian noise and applying a reverse diffusion process to generate a latent representation of the audio waveform. Furthermore, the waveform VAE decodes this latent representation back into a complete audio waveform.

As illustrated in FIG. 3, an input waveform is input into a VAE Encoder to generate an audio latent representation. The output of the VAE Encoder is input into a diffusion process to generate a noisy latent representation of the input audio. The noisy latent representation is input into a first difustion transform (DiT) (e.g., EzDIT). The output of the first DiT is input into a second DiT. The output of the second DiT transfer corresponds to a modified audio latent representation. A VAE Decoder converts the modified audio latent representation to an output waveform. The first DiT and second DiT may receive a text prompt. The text prompt may be an instruction regarding the processing of the input audio. For example, the input audio may be a cat sound, and the text prompt may be an instruction to convert the cat sound to a dog sound. In another example, the input audio may be in the English language, and the text prompt may be an instruction to cover the input audio to the French language.

In one or more examples, the text encoder may be based on FLAN-T5, which has shown outstanding performance in T2A tasks. The latent diffusion model incorporates velocity (v) prediction and a Zero-SNR diffusion n scheduler, which have been proven effective in diffusion-based generation tasks. The core neural network of the LDM, termed EzAudio-DiT, is a diffusion transformer specifically designed for T2A generation.

For the waveform VAE, the design draws inspiration from Stable Audio and DAC, utilizing a fully convolutional autoencoder with snake activation functions and a VAE bottleneck for improved efficiency. The VAE may be trained using a combination of KL divergence, reconstruction loss, and GAN losses to ensure a well-behaved latent space with Gaussian-distributed embeddings and high-quality audio reconstructions. The VAE may be trained on large-scale audio datasets such as AudioSet, enabling it to handle a wide variety of audio types and sources.

To optimize the DiT for text-to-audio tasks, several novel techniques are introduced to improve memory and parameter efficiency, convergence speed, and training stability:

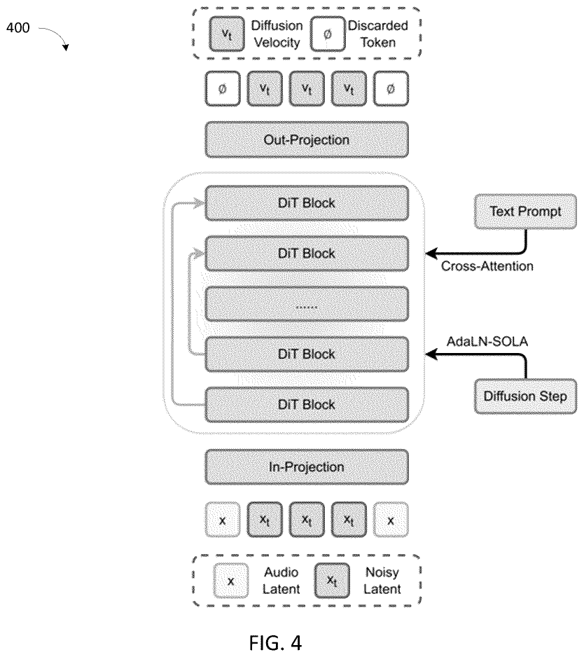

Adaptive Layer Normalization layers (AdaLN) are essential in handling diffusion steps and image class conditions in DiT architectures. However, when combined with cross-attention for text input processing, AdaLN's tasks become simpler, allowing for a reduction in model size and memory usage. Previous approaches, such as AdaLN-Single, aimed to simplify this by using a single shared AdaLN layer across all DiT blocks. However, it was determined that AdaLN-Single caused performance degradation and unstable training. To solve these issues, the embodiments of the present disclosure use AdaLN-Single Orchestrated by Low-rank Adjustment (AdaLN-SOLA). In one or more examples, AdaLN-SOLA uses one shared AdaLN module across DiT blocks, while each block applies a low-rank matrix that adapts the diffusion step input to maintain model performance and numerical stability. FIG. 4 illustrates an example system architecture 400 that uses AdaLN-SOLA. Each DiT block in FIG. 4 may belong to one of the DiT transformers illustrated in FIG. 3.

In one or more examples, Long-Skip Connection is used. In diffusion models, low-level features contain critical information for accurate noise or velocity estimation. In the case of T2A generation using latent waveform embeddings, which typically consist of 128 channels, transformers face difficulty retaining detailed input information. To address this, long-skip connections are employed to pass low-level features directly to later transformer blocks, ensuring that the model retains crucial information for high-quality audio reconstruction, as shown in FIG. 4. For example, as illustrated in FIG. 4, output of one DiT block is provided to another non-consecutive DiT block.

To further stabilize training and improve convergence, QK-Norm may be applied in attention layers, while LayerNorm may be introduced after the fusion of long-skip connections. Furthermore, Rotary Position Embedding (RoPE) may be employed to enhance the efficiency of position encoding, accelerating convergence and improving model performance.

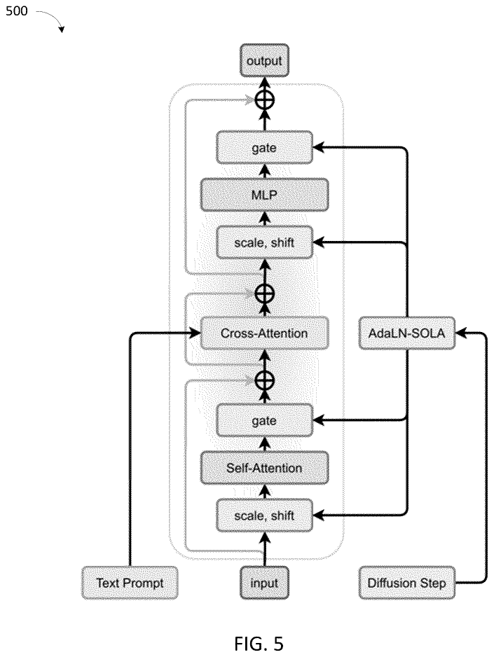

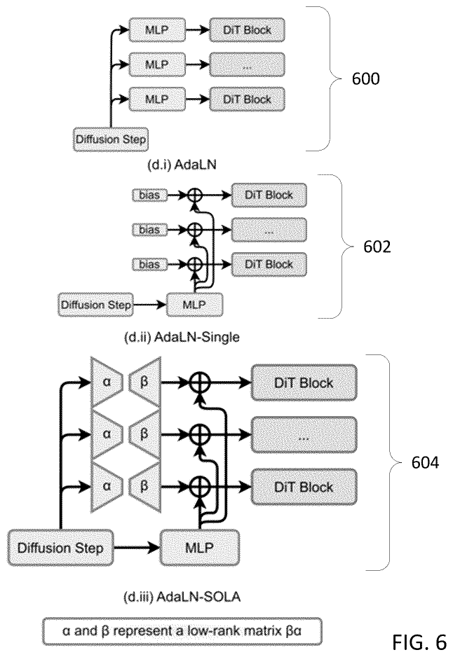

FIG. 5 illustrates an example architecture 500 in which AdaLN-SOLA is applied to scale, shift and gate processes. FIG. 6 illustrates an example AdaLN architecture 600, an example AdaLN-Single architecture 602, and an example AdaLN-SOLA architecture 604.

To maximize the potential of the diffusion transformer, a multi-stage training strategy may be adopted. This strategy addresses the lack of large-scale annotated audio datasets through the following stages.

In one or more examples, masked diffusion modeling may be used during training. Masked modeling has demonstrated significant success in transformer-based and diffusion models. In this stage, a large-scale dataset (e.g., AudioSet), may be used for self-supervised pre-training. Portions of the input tokens (representing audio) are randomly masked with diffusion noise, and the model is trained to reconstruct these tokens using the unmasked ones. This stage enables the model to learn acoustic dependencies without text conditioning, functioning as an unconditional model when fully masked.

In one or more examples, synthetic caption data generation may be used during training. Given the scarcity of annotated audio datasets, synthetic captions may be generated to facilitate text-to-audio alignment learning. Several datasets are used, including Auto-ACD and AS-Qwen-Caps, both of which provide large volumes of captions for audio datasets like AudioSet and VGGSound. Additionally, captions are generated using OpenAI's GPT-40-mini API for the strongly labeled subset of AudioSet. To filter out low-quality captions, a filtering mechanism inspired by CapFilt may be employed, utilizing pre-trained CLAP models to discard caption pairs with low similarity scores.

In one or more examples, fine-tuning may be used during training. In the final stage, the model is fine-tuned using human-labeled datasets, such as AudioCaps, ensuring the generation of high-quality and accurately aligned audio outputs. This fine-tuning step improves the overall performance and accuracy of the model.

According to one or more embodiments, Classifier-Free Guidance (CFG) may be used during diffusion sampling to enhance the prompt alignment of generated audio. In one or more examples, the CFG process modifies the predicted velocity (v) during reverse diffusion according to:

$${v}_{cfg} = {v}_{neg} + w ( {v}_{pos} - {v}_{neg} ) , \qquad Eq . ( 1 )$$

where w is the guidance scale, and vₚₒₛ and v_{neg} represent model outputs under positive and negative prompts, with v_{cfg} being the adjusted velocity. By default, the negative prompt is set to empty, corresponding to the unconditional case.

A higher guidance scale enhances prompt alignment, but may result in over-exposure, impairing generation quality. To address this, a CFG rescaling technique is used to adjust the magnitude of v_{cfg} while preserving its direction when a large w is employed.

$${v}_{re} = {v}_{cfg} \cdot std ( {v}_{pos} ) \cdot {std ( {v}_{cfg} )}^{- 1} , \qquad Eq . ( 2 )$$

$${{v}^{′}}_{cfg} = ϕ \cdot {v}_{re} + ( 1 - ϕ ) \cdot {v}_{cfg} , \qquad Eq . ( 3 )$$

where φ is the rescaling factor, with v′ denoting the refined CFG velocity for diffusion sampling.

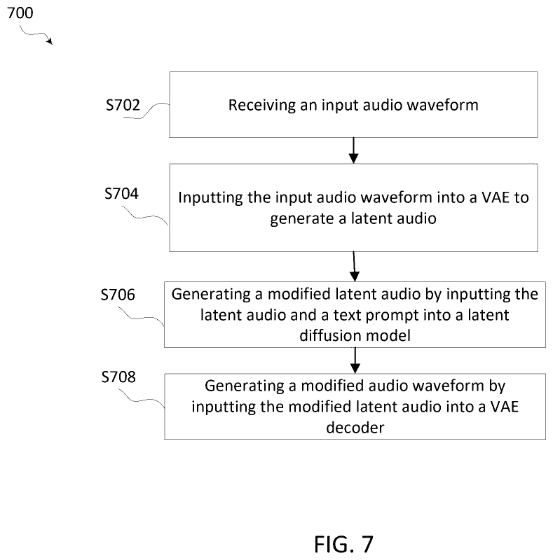

FIG. 7 illustrates a flowchart of an example process 700 for generating an output audio waveform based on an input audio waveform. The process 700 may be implemented by processor 220 (FIG. 7).

The process may start at operation S702 where an input audio wave form is received.

The process proceeds to operation S704 where the input audio waveform is input into a VAE to generate a latent audio representation of the input waveform.

The process proceeds to operation S706 where a modified latent audio is generated by inputting the latent audio and a text prompt into a latent diffusion model. For example, the text prompt may be an instruction regarding the conversion of the input audio. The latent diffusion model may be implemented in accordance with FIG. 3.

The process proceeds to operation S708 where a modified audio waveform is generated by inputting the modified latent audio into a VAE decoder.

The embodiments of the present disclosure provide a LDM (EzAudio), which is a novel and highly efficient framework for text-to-audio (T2A) generation. By leveraging an optimized diffusion transformer (DiT) architecture, a streamlined multi-stage training pipeline, and an innovative classifier-free guidance (CFG) rescaling technique, EzAudio delivers state-of-the-art performance while remaining easy to deploy and use. The system generates highly realistic audio, setting a new standard in T2A tasks with superior quality and precise text-audio alignment. The embodiments result in the following advantages:

The embodiments result in an efficient DiT Architecture. Particularly, the embodiments introduce an optimized diffusion transformer specifically designed for T2A tasks, incorporating innovations such as AdaLN-SOLA and long-skip connections. These modifications improve memory and parameter efficiency, enhance convergence speed, and stabilize training, allowing for faster and more effective audio generation.

The embodiments utilize waveform VAE for latent audio representation. By utilizing a 1D waveform VAE instead of 2D mel spectrograms, EzAudio avoids the complexities associated with spectrogram-based models, eliminating the need for additional neural vocoders while preserving temporal resolution and reducing computational costs.

The embodiments provide a data-efficient training pipeline. To address the scarcity of labeled audio data, the embodiments adopt a multi-stage training strategy that leverages masked modeling and synthetic caption generation, enabling the model to learn robust audio representations from both unlabeled and automatically generated data. This approach ensures high-quality text-to-audio alignment and improves overall generation performance.

The embodiments utilize classifier-free guidance rescaling. To simplify the diffusion sampling process, a novel CFG rescaling technique that allows for stronger prompt alignment without sacrificing audio quality is introduced. This technique provides a flexible yet robust method for balancing CFG scores, making the model easier to use while maintaining optimal performance.

The embodiments have applications in areas such as voice and music generation.

The proposed methods disclosed herein may be implemented by processing circuitry (e.g., one or more processors or one or more integrated circuits). In one example, the one or more processors execute a program that is stored in a non-transitory computer-readable medium to perform one or more of the proposed methods.

The techniques described above may be implemented as computer software using computer-readable instructions and physically stored in one or more computer-readable media.

Embodiments of the present disclosure may be used separately or combined in any order. Further, each of the embodiments (and methods thereof) may be implemented by processing circuitry (e.g., one or more processors or one or more integrated circuits). In one example, the one or more processors execute a program that is stored in a non-transitory computer-readable medium.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method performed by at least one processor, the method comprising:
receiving an input audio waveform;
inputting the input audio waveform into a variational autoencoder (VAE) to generate a latent representation of the input audio waveform;
generating a modified latent representation of the input audio waveform by inputting the latent representation of the input audio waveform and a text prompt into a latent diffusion model; and
generating a modified audio waveform by inputting the modified latent representation of the input audio waveform into a VAE decoder.

2. The method according to claim 1, wherein the text prompt includes a text description regarding the modified audio waveform.

3. The method according to claim 2, further comprising:
inputting the text prompt into a text encoder to generate a feature embedding,
wherein the latent diffusion model generates the modified latent representation of the input audio waveform based on the feature embedding.

4. The method according to claim 1, wherein the generating the modified latent representation of input audio waveform further comprises:
performing a diffusion process on the latent representation of the input audio to generate a noisy latent representation of the input audio waveform.

5. The method according to claim 4, wherein the generating the modified latent representation of input audio waveform further comprises:
inputting the noisy latent representation of the input audio waveform into a first diffusion transformer; and
inputting an output of the first diffusion transformer into a second diffusion transformer to generate the modified latent representation of the input audio waveform.

6. The method according to claim 5, wherein the first diffusion transformer is a first neural network, and the second diffusion transformer is a second neural network.

7. The method according to claim 5, wherein the generating the modified latent representation of the input audio waveform further comprises:
applying an adaptive layer normalization with low-rank adjustment to each diffusion transformer.

8. The method according to claim 5, wherein each of the first diffusion transformer and the second diffusion transformer each comprise a plurality of transformer blocks, and
wherein the generating the modified latent representation of the input audio waveform further comprises:
applying one or more long-skip connections in which one or more low level features are provided from a first transformer block from the plurality of transformer blocks to a second transformer block from the plurality of transformer blocks,
wherein the first transformer block and the second transformer block are non-consecutive block.

9. The method according to claim 1, wherein the latent diffusion model is trained based on one or more tokens masked with diffusion noise, wherein the latent diffusion model is trained to reconstruct the one or tokens masked with noise using one or more corresponding tokens that are not masked with noise.

10. The method according to claim 1, wherein the latent diffusion model is trained based on annotated data set comprising synthetic captions to facilitate text-to-audio alignment learning.

11. The method according to claim 1, wherein a classifier-free guidance (CFG) is used during diffusion sampling for alignment of generated audio.

12. An apparatus comprising:
at least one memory configured to store program code; and
at least one processor configured to read the program code and operate as instructed by the program code, the program code including:
receiving code configured to cause the at least one processor to receive an input audio waveform;
first inputting code configured to cause the at least one processor to input the input audio waveform into a variational autoencoder (VAE) to generate a latent representation of the input audio waveform;
first generating code configured to cause the at least one processor to generate a modified latent representation of the input audio waveform by inputting the latent representation of the input audio waveform and a text prompt into a latent diffusion model; and
second generating code configured to cause the at least one processor to generate a modified audio waveform by inputting the modified latent representation of the input audio waveform into a VAE decoder.

13. The apparatus according to claim 12, wherein the text prompt includes a text description regarding the modified audio waveform.

14. The apparatus according to claim 13, wherein the program code further includes:
second inputting code configured to cause the at least one processor to input the text prompt into a text encoder to generate a feature embedding,
wherein the latent diffusion model generates the modified latent representation of the input audio waveform based on the feature embedding.

15. The apparatus according to claim 12, wherein the first generating code further causes the at least one processor to:
perform a diffusion process on the latent representation of the input audio to generate a noisy latent representation of the input audio waveform.

16. The apparatus according to claim 15, wherein the first generating code further causes the at least one processor to:
input the noisy latent representation of the input audio waveform into a first diffusion transformer; and
input an output of the first diffusion transformer into a second diffusion transformer to generate the modified latent representation of the input audio waveform.

17. The apparatus according to claim 16, wherein the first diffusion transformer is a first neural network, and the second diffusion transformer is a second neural network.

18. The apparatus according to claim 16, wherein the first generating code further causes the at least one processor to:
apply an adaptive layer normalization with low-rank adjustment to each diffusion transformer.

19. The apparatus according to claim 16, wherein each of the first diffusion transformer and the second diffusion transformer each comprise a plurality of transformer blocks, and
wherein the first generating code further causes the at least one processor to:
apply one or more long-skip connections in which one or more low level features are provided from a first transformer block from the plurality of transformer blocks to a second transformer block from the plurality of transformer blocks,
wherein the first transformer block and the second transformer block are non-consecutive block.

20. A non-transitory computer readable medium having instructions stored therein, which when executed by a processor cause the processor to execute a method comprising:
receiving an input audio waveform;
inputting the input audio waveform into a variational autoencoder (VAE) to generate a latent representation of the input audio waveform;
generating a modified latent representation of the input audio waveform by inputting the latent representation of the input audio waveform and a text prompt into a latent diffusion model; and
generating a modified audio waveform by inputting the modified latent representation of the input audio waveform into a VAE decoder.
